(19) United States
(12) Patent Application Publication
(10) Pub. No.: US 2024/0045414 A1
(43) Pub. Date: Feb. 8, 2024

(54) INTELLIGENT MITIGATION OR PREVENTION OF EQUIPMENT PERFORMANCE DEFICIENCIES

(71) Applicant: AMGEN INC., Thousand Oaks, CA (US)

(72) Inventors: Saleh Alkhalifa, Medford, MA (US); Daniel Vagle, Boston, MA (US); Christopher John Garvin, Kingston, RI (US)

(21) Appl. No.: 18/269,015

(22) PCT Filed: Jan. 3, 2022
(86) PCT No.: PCT/US22/11007

§ 371 Date: Jun. 22, 2023

Related U.S. Application Data
(60) Provisional application No. 63/133,554, filed on Jan. 4, 2021.

(51) Int. Cl. G05B 23/02

(52) U.S. Cl. CPC G05B 23/0254; G05B 23/0221; G05B 23/0275

(57) ABSTRACT

A method of diagnosing or predicting performance of equipment includes determining values of one or more parameters associated with the equipment by monitoring the one or more parameters over a time period in which the equipment is in use. The method also includes determining, by processing the values of the one or more parameters using a classification model, a performance classification of the equipment, mapping the performance classification to a mitigating or preventative action, and generating an output indicative of the mitigating or preventative action.

### FIELD OF THE DISCLOSURE

The present application generally relates to equipment that can be used in manufacturing, product development, and/or other processes (e.g., equipment used to develop or commercially manufacture a pharmaceutical product), and more specifically relates to the identification of actions that can mitigate or prevent performance deficiencies relating to such equipment.

### BACKGROUND

In various development and production contexts, different types of equipment are relied upon to provide output (e.g., physical products) with a sufficiently high level of quality. To manufacture biopharmaceutical drug products, for example, the requisite equipment may include media holding tanks, filtration equipment, bioreactors, separation equipment, purification equipment, and so on. In some cases, the equipment can include or be associated with auxiliary devices, such as sensors (e.g., temperature and/or pressure probes) that enable real-time or near real-time monitoring of the process. When such monitoring is available, subject matter experts or teams can leverage their training and experience to identify problems with the equipment, or to predict the onset of problems with the equipment, preferably at a time before the equipment is used for its primary purpose (e.g., used for product development or commercial manufacture of the product). For example, a subject matter expert may observe particular patterns or behaviors in a monitored temperature within a tank that is used for a “steam-in-place” sterilization procedure, and apply his or her personal knowledge to theorize that the patterns or behaviors are the result of a faulty steam trap, improper temperature probe calibration, or some other specific root cause. The subject matter expert may then apply his or her personal knowledge to determine an appropriate action or actions to take in response to the diagnosis (e.g., checking and/or replacing the steam trap, or recalibrating the temperature probes, etc.), and either complete the action(s) or request completion of the action(s).

However, this expertise is typically specific to each individual or team, and therefore can be inconsistently applied across locations (e.g., plants or laboratories) and over time (e.g., as key employees leave). Moreover, subject matter experts may fail to note particular warning signs, such as when signals indicative of an equipment problem (e.g., brief dips in sensor readings, etc.) are intermittent. Even if subject matter experts could accurately and consistently identify problems or potential problems, the process would generally be time consuming, and the costs high (e.g., due to the number of man-hours required from highly skilled individuals). In some contexts, the costs associated with continuous manual monitoring are prohibitive, and so “second best” practices are instead employed. For example, some equipment may be maintained (e.g., inspected, calibrated, etc.) on a regular calendar basis (e.g., once per three months or once per year) or on a usage basis (e.g., after every 100 hours of use, or after every “run”) in order to lower the likelihood of problems. However, this can result in an unnecessarily high expenditure of resources (if maintenance is performed more often than needed) or an unacceptably high number or frequency of performance issues (if maintenance is performed less often than needed).

### BRIEF SUMMARY

To address some of the aforementioned drawbacks of current/conventional practices, embodiments described herein include systems and methods that automate and improve the identification of equipment performance issues/deficiencies, as well as the determination of which actions to take based on those issues/deficiencies. The equipment may be any type of device or system used in a particular process, such as a sterilization or holding tank, a bioreactor, and so on, and in some embodiments may include some or all of the sensor device(s) used to monitor the equipment. While the examples provided herein relate primarily to pharmaceutical manufacture or development, it is understood that the systems and methods disclosed herein provide an equipment-agnostic platform that can be applied to equipment designed for use in other contexts (e.g., equipment used in non-pharmaceutical development or manufacture processes such as for food, textiles, automobiles, etc.).

To identify equipment performance issues, a classification model is trained using historical data. The classification model may be trained using collections of historical sensor readings for time periods in which a particular piece of equipment was used (or in which multiple, similar pieces of equipment were used), along with labels indicating how subject matter experts or teams classified any performance issues, or the lack thereof, for each such time period. For example, for a given set of input data, a subject matter expert may assign a label selected from the group consisting of [“Good,” “Failure Type 1,” . . . “Failure Type N”], where N is an integer greater than or equal to one. It is understood that, as used herein, the term “expert” does not necessarily indicate any minimum level of qualifications (e.g., training, knowledge, experience, etc.), although it may in some embodiments. To determine which features (e.g., which sensor readings) are used to train the classification model, principal component analysis or other suitable techniques may be used to determine which features are most predictive of particular performance issues.

Once trained, the classification model may be configured to operate on new data (e.g., real-time sensor readings over a predetermined time window) to diagnose/infer when equipment of the same (or at least similar) type is experiencing a specific type of deficiency, or to predict when the equipment is going to experience a specific type of deficiency. For example, for a given set of input data (corresponding to the features used during training) in a given time window, the classification model may output a classification that corresponds to one of the labels used during training (e.g., “Good,” “Failure Type 1,” etc.).

Further, in some embodiments, a computing system (possibly, but not necessarily, the same computing device that trains and/or runs the classification model) may map the output of the classification model to a particular action or set of actions to be taken, in order to rectify the diagnosed performance problem, or to prevent a predicted performance problem from occurring. The computing system may also notify one or more users of the recommended action(s), and possibly also notify the user(s) of the diagnosed or predicted performance issue that was mapped to the action(s), in order to instigate completion of the action(s). The computing system may perform the mapping by accessing a database that includes a repository of subject matter expert knowledge, for example. Further, in some embodiments, individuals (e.g., subject matter experts) may enter information to confirm whether particular classifications output by the classification model were correct, and the computing system may use this information as training labels to further improve the accuracy of the classification model.

The systems and methods disclosed herein can identify problems and/or potential problems relating to equipment with improved reliability/consistency, and with far greater speed, as compared to the conventional practices described in the Background section above. This, in turn, can reduce the risks and costs associated with equipment performance failures or other deficiencies that might otherwise occur during production (or during development, etc.). Moreover, due to a reduced need for human monitoring, labor costs may be greatly reduced. Further, in some embodiments, costs associated with excessive maintenance can be reduced—without a corresponding increase in the risk of equipment failures/deficiencies—by triggering maintenance activities when those activities are truly needed, and not merely based on the passage of time or the level of equipment usage. The systems and methods described herein can also exhibit increased accuracy over time (e.g., by further training based on user confirmation of model classifications), and can facilitate the identification of previously unrecognized equipment deficiency types/modes.

### BRIEF DESCRIPTION OF THE DRAWINGS

The skilled artisan will understand that the figures, described herein, are included for purposes of illustration and are not limiting on the present disclosure. The drawings are not necessarily to scale, emphasis instead being placed upon illustrating the principles of the present disclosure. It is to be understood that, in some instances, various aspects of the described implementations may be shown exaggerated or enlarged to facilitate an understanding of the described implementations. In the drawings, like reference characters throughout the various drawings generally refer to functionally similar and/or structurally similar components.

FIG. 1 is a simplified block diagram of an example system that may be used to diagnose or predict deficiencies for equipment used in a particular process, identify appropriate actions based on those deficiencies, and notify users of the identified actions.

FIG. 2 depicts an example process that may be implemented by the computing system of FIG. 1.

FIG. 3 depicts a plot showing example sensor readings that correspond to different equipment deficiency modes.

FIG. 4 depicts a plot showing example classifications made by a support vector machine (SVM) classification model.

FIG. 5 depicts an example presentation that may be generated and/or populated by the computing system of FIG. 1.

FIG. 6 is a flow diagram of an example method for mitigating or preventing equipment performance deficiencies.

### DETAILED DESCRIPTION

The various concepts introduced above and discussed in greater detail below may be implemented in any of numerous ways, and the described concepts are not limited to any particular manner of implementation. Examples of implementations are provided for illustrative purposes.

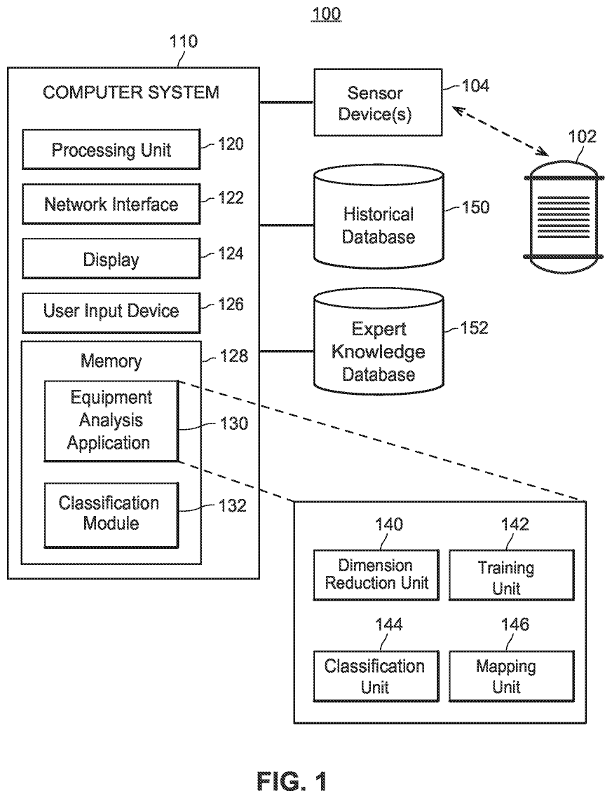

FIG. 1 is a simplified block diagram of an example system 100 that may diagnose or predict deficiencies for equipment 102 used in a particular process, identify appropriate actions based on those deficiencies, and notify users of the identified actions. In some embodiments, the equipment 102 is a physical device or system (e.g., a collection of interrelated devices/components) configured for use in a commercial production process, such as a biopharmaceutical drug manufacturing process. In other embodiments, the equipment 102 is a physical device or system configured for use in a different type of process, such as a product development process. More specific examples of processes in which the equipment 102 may be used include formulation, hydration, cell culture, harvesting, separation, purification, and final fill and finish processes. To provide just a few examples, the equipment 102 may be a sterilization tank, a media hold tank, a filter, a bioreactor, a centrifuge, and so on. In other embodiments, the equipment 102 is equipment that is used in a process unrelated to pharmaceutical development or production (e.g., a food manufacturing plant, an oil processing plant, etc.).

The system 100 also includes one or more sensor devices 104, which are configured to sense physical parameters associated with the equipment 102 and/or its contents or proximate external environment. For example, the sensor device(s) 104 may include one or more temperature sensors (e.g., to take readings of internal, surface, and/or external temperatures of the equipment 102 during operation), one or more pressure sensors (e.g., to take readings of internal and/or external pressures of the equipment 102 during operation), and/or one or more other sensor types. As a more specific example, the equipment 102 may be a sterilization tank, and the sensor device(s) 104 may include multiple temperature sensors at different positions within the tank. The sensor device(s) 104 may include sensors that only take direct measurements (e.g., temperature, pressure, flow rate, etc.), and/or “soft” sensing devices or systems that determine parameter values indirectly (e.g., a Raman analyzer and probe to determine chemical composition and molecular structure in a non-destructive manner), as is appropriate for the type of the equipment 102 and the operation for which the equipment 102 is configured to be used.

The sensor device(s) 104 may include one or more devices integrated on or within the equipment 102, and/or one or more devices affixed to or otherwise placed in proximity with the equipment 102. Depending on the embodiment, none, some, or all of the sensor device(s) 104 may be viewed as a part of the equipment 102. In particular, in embodiments where the performance of any or all of the sensor device(s) 104 is included in the equipment performance analysis (as described further below), references herein to “the equipment 102” includes those sensor device(s) 104. For example, an analysis of the performance of a sterilization tank may encompass not only analyzing the ability of the tank to do its intended task (e.g., hold the desired contents without leaks, and subject the contents to a desired temperature profile), but also analyzing the performance of a number of temperature sensors affixed to or integrated with the tank.

The system 100 also includes a computing system 110 coupled to the sensor device(s) 104. As discussed in further detail below, the computing system 110 may include a single computing device, or multiple computing devices (e.g., one or more servers and one or more client devices) that are either co-located or remote from each other. The computing system 110 is generally configured to: (1) analyze the readings generated by the sensor device(s) 104 in order to infer/diagnose or predict/anticipate deficiencies (e.g., faults or otherwise unacceptable performance) of the equipment 102; (2) identify actions that should be taken based on the inferred or predicted deficiencies; and (3) notify users of the identified actions. In the example embodiment shown in FIG. 1, the computing system 110 includes a processing unit 120, a network interface 122, a display 124, a user input device 126, and a memory 128.

The processing unit 120 includes one or more processors, each of which may be a programmable microprocessor that executes software instructions stored in the memory 128 to execute some or all of the functions of the computing system 110 as described herein. Alternatively, one or more of the processors in the processing unit 120 may be other types of processors (e.g., application-specific integrated circuits (ASICs), field-programmable gate arrays (FPGAs), etc.).

The network interface 122 may include any suitable hardware (e.g., front-end transmitter and receiver hardware), firmware, and/or software configured to use one or more communication protocols to communicate with external devices and/or systems (e.g., the sensor device(s) 104, or a server, not shown in FIG.1, that provides an interface between the computing system 110 and the sensor device(s) 104, etc.). For example, the network interface 122 may be or include an Ethernet interface. While not shown in FIG. 1, the computing system 110 may communicate with the sensor device(s) 104, and/or with any device(s) that provide an interface between the computing system 110 and the sensor device(s) 104, via a single communication network, or via multiple communication networks of one or more types (e.g., one or more wired and/or wireless local area networks (LANs), and/or one or more wired and/or wireless wide area networks (WANs) such as the Internet or an intranet, etc.).

The display 124 may use any suitable display technology (e.g., LED, OLED, LCD, etc.) to present information to a user, and the user input device 126 may be a keyboard or other suitable input device. In some embodiments, the display 124 and the user input device 126 are integrated within a single device (e.g., a touchscreen display). Generally, the display 124 and the user input device 126 may combine to enable a user to view and/or interact with visual presentations (e.g., graphical user interfaces or displayed information) output by the computing system 110, e.g., for purposes such as notifying users of equipment faults or other deficiencies, and recommending any mitigating or preventative actions for the users to take.

The memory 128 may include one or more physical memory devices or units containing volatile and/or non-volatile memory, and may include memories located in different computing devices of the computing system 110. Any suitable memory type or types may be used, such as read-only memory (ROM), solid-state drives (SSDs), hard disk drives (HDDs), and so on. The memory 128 stores the instructions of one or more software applications, including an equipment analysis application 130. The equipment analysis application 130, when executed by the processing unit 120, is generally configured to train a classification model 132, to use the trained classification model 132 to infer or predict deficient equipment performance (i.e., for equipment 102 and possibly also other equipment), to identify remedial actions, and to notify users of the deficiencies and corresponding actions. To this end, the equipment analysis application 130 includes a dimension reduction unit 140, a training unit 142, a classification unit 144, and a mapping unit 146. The units 140 through 146 may be distinct software components or modules of the equipment analysis application 130, or may simply represent functionality of the equipment analysis application 130 that is not necessarily divided among different components/modules. For example, in some embodiments, the classification unit 144 and the training unit 142 are included in a single software module. Moreover, in some embodiments, the different units 140 through 146 may be distributed among multiple copies of the equipment analysis application 130 (e.g., executing at different devices in the computing system 110), or among different types of applications stored and executed at one or more devices of the computing system 110. The operation of each of the units 140 through 146 is described in further detail below, with reference to the operation of the system 100.

The classification model 132 may be any suitable type of classifier, such as a support vector machine (SVM) model, a decision tree model, a deep neural network, a k-nearest neighbor (KNN) model, a naive Bayes classifier (NBC) model, a long short-term memory (LSTM) model, an HDBSCAN clustering model, or any other model that can classify sets of input data into one of two or more possible classifications. In some embodiments, the classification model 132 also operates upon the values of one or more other types of parameters, in addition to those generated by the sensor device(s) 104. For example, in addition to the readings from the sensor device(s) 104, the classification model 132 may accept a time parameter value as an input (e.g., the number of minutes or hours since a process started). In some embodiments, the classification model 132 accepts one or more categorical parameters as inputs (e.g., 0 or 1, or category A, B, or C, etc.). A categorical (e.g., binary) parameter may represent whether a particular operation occurred, whether a particular substance was added, and so on. Moreover, the classification model 132 may accept one or more inputs that reflect a “memory” component. For example, one parameter may be a temperature reading from a probe at x minutes, while another may be a temperature reading from the same probe at x−1 minutes, and so on. In other embodiments, the classification model 132 itself has a memory component (i.e., the classification model 132 is “stateful”).

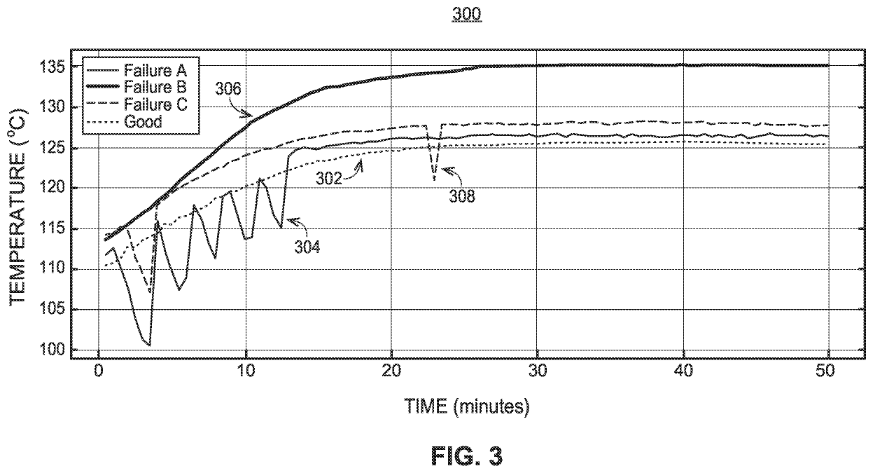

Depending on the embodiment, the classification model 132 may classify sets of inputs (parameter values) as one of two possible classifications (e.g., “good performance” or “poor performance”), or as one of more than two possible classifications (e.g., “Good,” “Failure Type A,” or “Failure Type B”). Some examples of sensor readings that may correspond to good performance, or to specific types of equipment deficiencies, are discussed below in connection with FIG. 3. In some embodiments, the classification model 132 comprises two or more individually trained models, which may operate on the same set of inputs or on different (possibly overlapping) sets of inputs. For example, the classification model 132 may include a KNN model that classifies a set of parameter values as “Good” or “Poor,” and also include a neural network that only analyzes the “Poor” sets of data, and classifies those each of those data sets as a particular type of failure or other deficiency. As another example, the classification model 132 may include a number of different neural networks, each of which is specifically trained to detect a respective type of equipment deficiency.

As will also be described in further detail below, the computing system 110 is configured to access a historical database 150 for training purposes, and is configured to access an expert knowledge database 152 to identify recommended actions. The historical database 150 may store parameters values associated with past runs of the equipment 102 and/or past runs of other, similar equipment. For example, the historical database 150 may store sensor readings that were generated by the sensor device(s) 104 (and/or by other, similar sensor devices), and possibly also values of other relevant parameters (e.g., time). The historical database 150 may also store “label” information indicating a particular equipment deficiency, or the lack of any such deficiency, for each set of historical parameter values. For example, some sets of sensor readings may be associated with “Good” labels in the historical database 150, other sets of sensor readings may be associated with “Failure Type 1” labels in the historical database 150, and so on.

The expert knowledge database 152 may be a repository of information representing actions that subject matter experts took in the past in order to mitigate or prevent equipment issues (for the equipment 102 and/or similar equipment) when certain types of equipment deficiencies were identified. For example, the expert knowledge database 152 may include one or more tables that associate each of the deficiency types represented by the labels of the historical database 150 (e.g., “Failure Type 1,” etc.) with one or more appropriate actions that could mitigate or prevent the corresponding problem. The databases 150, 152 may be stored in a persistent memory of the memory 128, or in a different persistent memory of the computing system 110 or another device or system. In some embodiments, the computing system 110 accesses one or both of the databases 150, 152 via the Internet using the network interface 122.

As noted above, the computing system 110 may include one device or multiple devices and, if multiple devices, may be co-located or remotely distributed (e.g., with Ethernet and/or Internet communication between the different devices). In one embodiment, for example, a first server of the computing system 110 (including units 140, 142) trains the classification model 132, a second server of the computing system 110 collects real-time measurements from the sensor device(s) 104, and a third server of the computing system 110 (including units 144, 146) receives the measurements from the second server and uses a copy of the trained classification model 132 to generate classifications (i.e., diagnoses or predictions) based on the received measurements. As another example, the third server of the above example does not store a copy of the trained classification model 132, and instead utilizes the classification model 132 by providing the measurements to the second server (e.g., if the classification model 132 is made available via a web services arrangement). As used herein, unless the context of the usage of the term clearly indicates otherwise, terms such as “running,” “using,” “implementing,” etc., a model such as classification model 132 are broadly used to encompass the alternatives of directly executing a locally stored model, or requesting that another device (e.g., a remote server) execute the model. It is understood that still other configurations and distributions of functionality, beyond those shown in FIG. 1 and/or described herein, are also possible and within the scope of the invention.

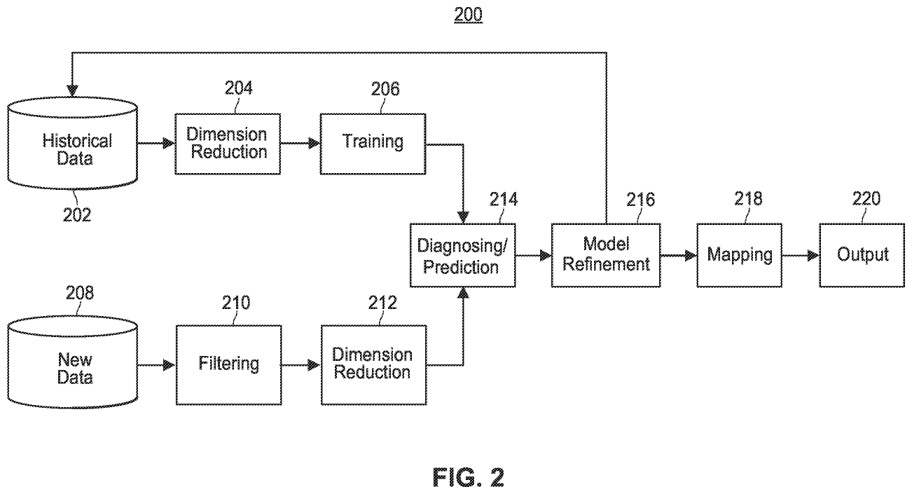

Operation of the system 100 will now be described in further detail, with reference to both the components of FIG. 1 and the process 200 depicted in FIG. 2. First, in an initial training phase, the equipment analysis application 130 retrieves historical data 202 (e.g., including past sensor readings) from the historical database 150. At stage 204 of the process 200, the dimension reduction unit 140 combines (e.g., forms a linear combination of) the parameter values in the historical data 202 to generate a smaller number of values, each of which strongly contributes to the classifications made by the classification model 132. For example, the dimension reduction unit 140 may process the parameter values from the historical data 202 using principal component analysis (PCA), probabilistic principal component analysis (PPCA), Bayesian probabilistic principal component analysis (BPPCA), Gaussian mixture models (GMM), or another suitable technique. The dimension reduction unit 140 may reduce the sensor readings (and possibly other input values) to any suitable number of dimensions (e.g., two, three, five, etc.).

After stage 204, at stage 206 of the process 200, the training unit 142 trains the classification model 132 using the parameter values generated at stage 204. For example, if the dimension reduction unit 140 implements a PCA technique to reduce the original parameter values (e.g., historical readings from sensor devices) to values in two dimensions (PC1, PC2) at stage 204, then the training unit 142 may train the classification model 132 at stage 206 using those (PC1, PC2) values and their corresponding, manually-generated labels. In other embodiments, however, stage 204 is omitted from the process 200 and the dimension reduction unit 140 is omitted from the system 100. In this latter case, the training unit 142 may instead train the classification model 132 using the original parameter values from the historical data 202 as direct inputs. In either case, for good performance of the classification model 132, the historical data 202 should include numerous and diverse examples of each type of classification desired (e.g., “good” performance and one or more specific types of equipment deficiencies). The training unit 142 may also validate and/or further qualify the trained classification model 132 at stage 206 (e.g., using portions of the historical data 202 that were not used for training).

FIG. 3 depicts a plot 300 showing example sensor readings that may correspond to different equipment deficiency types/modes, in an example embodiment where the sensor device(s) 104 include temperature sensors and the equipment 102 includes a sterilization tank. Trace 302 in FIG. 3 represents the expected/desired (“good”) performance of the equipment 102, while three other traces 304, 306, 308 represent scenarios indicative of different types of equipment deficiencies. In particular, trace 304 depicts a scenario in which the temperature sensor reading is initially oscillating (during temperature ramp up), which can indicate problems with the temperature control system, or indicate system integrity issues. Trace 306 depicts an “overshoot” scenario in which the temperature is above the minimum sterilization temperature (and thus may not technically be an “error” state), which can also indicate problems with the temperature control system, or problems with temperature sensor calibration. Trace 308 depicts a “drop out” scenario in which the signal from the temperature sensor is briefly interrupted, which can cause a timer to restart the sterilization process, and therefore cause issues with equipment performance and longevity. Other types of deficiencies are also possible. For example, a fourth deficiency type/mode may correspond to oscillations that occur at a later time, after the temperature ramps up to a steady state, a fifth deficiency type/mode may correspond to an oscillation that is substantially lower in frequency than that shown in FIG. 3, a sixth deficiency type/mode may correspond to a drop out for a substantially longer time period than is shown in FIG. 3, a seventh deficiency type/mode may correspond to multiple drop outs, and so on. Ideally, in addition to recognizing/classifying good or acceptable performance, the classification model 132 is trained to recognize any of the possible types of equipment deficiencies, and to output a corresponding classification when that type of deficiency is inferred/diagnosed or predicted.

Returning now to FIG. 2, at stages 210 through 218, the classification unit 144 runs the trained classification model 132 on new (e.g., real-time or near real-time) data 208 (e.g., new sensor readings from the sensor device(s) 104) while the equipment 102 is in use. If the equipment 102 is a sterilization tank, for example, stages 210 through 218 may occur during multiple iterations of a sterilization (e.g., “steam-in-place”) procedure performed using the sterilization tank.

As the equipment 102 operates, the sensor device(s) 104 generate at least a portion of the new data 208. For example, the sensor device(s) 104 may each generate one real-time reading (e.g., temperature, pressure, pH level, etc.) per fixed time period (e.g., every five seconds, every minute, etc.). The type and frequency of the readings may match the data that was used during the training phase.

At stage 210, the equipment analysis application 130 (or other software) filters/pre-processes the new data 208. Stage 210 may apply a filter to ensure that only data from some pre-defined, current time window is retrieved, for example. As another example, the equipment analysis application 130 (or other software) pre-processes the sensor readings at stage 210 to put those readings in the same format as the historical data 202 that was used for training. If the sensor readings from the sensor device(s) 104 are captured less frequently than the sensor readings used during training, for example, then the equipment analysis application 130 may generate additional “readings” at stage 210 using an interpolation technique.

At stage 212, the dimension reduction unit 140, or a similar unit, reduces the dimensionality of the parameter values reflected by the new data 208 (possibly after processing at the filtering stage 210).

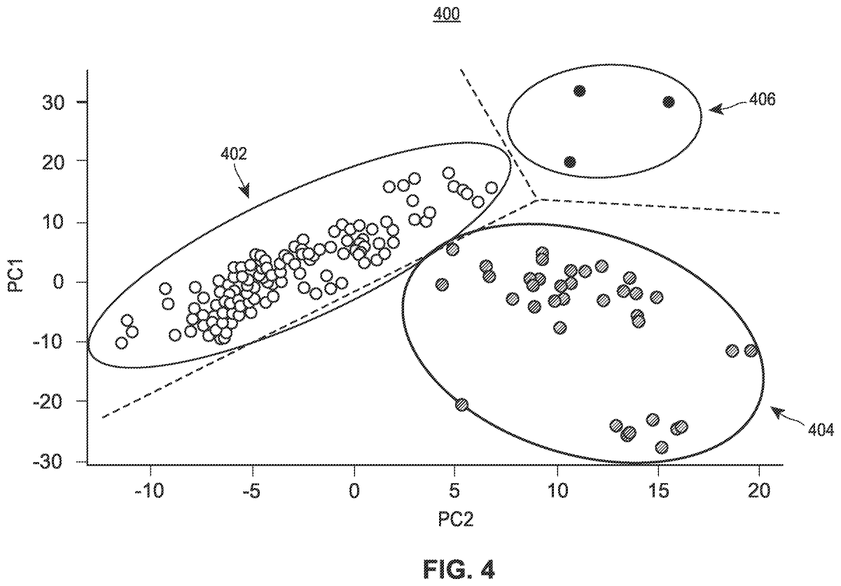

At stage 214, the classification unit 144 runs the trained classification model 132 using the parameter values generated at stage 212. For example, if the dimension reduction unit 140 implements a PCA technique to reduce the original parameter values (e.g., readings from the sensor device(s) 104) to values in two dimensions (PC1, PC2) at stage 212, the classification unit 144 may run the classification model 132 at stage 214 on those (PC1, PC2) values. An example of classification in one such embodiment, where the dimension reduction unit 140 reduces the input parameter values to two dimensions and the classification model 132 is an SVM model, is discussed below in connection with FIG. 4.

In alternative embodiments, stage 212 is omitted from the process 200, in which case the classification unit 144 may instead run the classification model 132 on the original parameter values from the new data 202 (possibly after processing at stage 210) as direct inputs. For example, the system 100 may omit the dimension reduction unit 140, and the process 200 may omit both stage 204 and stage 212.

The classification model 132 outputs a particular classification for each set of input data, e.g., for each of a number of uniform time periods while the equipment 102 is in use (e.g., every 10 minutes, or every hour, every six hours, every day, etc.). The classification may be an inference, i.e., a diagnosis of a current problem (e.g., failure/fault) exhibited by the equipment 102 or the lack thereof. Alternatively, the classification may be a prediction that the equipment 102 will exhibit a particular problem in the future, or a prediction that that equipment 102 will not exhibit problems in the future. In some embodiments, the classification model 132 is configured/trained to output any one of a set of classifications that includes both inferences and predictions. For example, classification “A” may indicate no present or expected problems for the equipment 102, classification “B” may indicate that the equipment 102 is currently experiencing a particular type of fault, classification “C” may indicate that the equipment 102 will likely experience a particular type of fault (or otherwise result in deficient performance) in the relatively near future if remedial actions are not taken, and so on.

At stage 216, the classifications output by the classification model 132 are provided back to the historical data 202, for use in further training (refinement) of the classification model 132. For this additional training, the equipment analysis application 130 or other software may provide a user interface for individuals (e.g., subject matter experts) to confirm whether a classification is correct, or to enter a correct classification if the output of the classification model 132 is incorrect. These manually-entered or confirmed classifications may then be used as labels for the additional training. The additional training can be particularly beneficial when the amount of historical data 202 available for the initial training was relatively small. In some embodiments, stage 216 is omitted from the process 200.

At stage 218, the mapping unit 146 maps the classification made by the classification model 132 to one or more recommended actions. To this end, the mapping unit 146 may use the classification as a key to a table stored in the expert knowledge database 152, for example. The corresponding action(s) may include one or more preventative/maintenance actions, and/or one or more actions to repair a current problem. For example, the mapping unit 146 may map a classification “Fault Type C” to an action to inspect and/or change a filter. In some embodiments, the mapping unit 146 maps at least some of the available classifications to sets of alternative actions that might be useful (e.g., if subject matter experts had, in the past, found that there were several different ways in which to best address a particular problem with the equipment 102 or similar equipment).

Some example mappings between deficiency classifications and corresponding actions in the expert knowledge database 152, for an embodiment in which the equipment 102 is a sterilization tank, are provided in the table below:

TABLE 1

| Classification (deficiency type) | Deficiency Description | Corresponding Action(s) |
|---|---|---|
| A | Temperature oscillates during warm up | Evaluate steam trap and regulator for |
| | (e.g., trace 304 of FIG. 3). | replacement. |
| B | Steam-in-place temperature overshoots | Calibrate or replace temperature |
| | target temperature (e.g., trace 306 of | sensors, and evaluate regulator for |
| | FIG. 3). | adjustment or replacement. |
| C | Brief temperature signal drop out, | If this is a repeat failure, calibrate |
| | causing the steam-in-place operation | temperature sensor and consider |
| | to restart (e.g., trace 308 of FIG. 3). | replacing. Check for extraneous matter |
| | | on steam trap, and evaluate steam trap |
| | | for replacement. |

In the above example, the classification model 132 may also support a fourth classification that corresponds to “good” performance, and therefore requires no mapping. In some embodiments, however, even a “good” classification requires a mapping (e.g., to one or more maintenance actions that represent a minimal or default level of maintenance).

At stage 220, the equipment analysis application 130 presents or otherwise provides the recommended action(s) to one or more system users. For example, the equipment analysis application 130 may generate or populate a graphical user interface or other presentation (or a portion thereof) at stage 220, for presentation to a user via the display 124 and/or one or more other displays/devices. The action(s) (and possibly the corresponding classification produced by the classification model 132) may be individually shown, and/or may be used to provide a view of higher-level statistics, etc. Additionally or alternatively, the equipment analysis application 130 may automatically generate an email or text notification for one or more users, including a message that indicates the recommended action(s) and the corresponding classification. The notifications may be provided in real-time, or nearly in real-time, as sensor data is made available (e.g., as soon as the last sensor readings within a given time window are generated by the sensor device(s) 104).

In some embodiments, the process 200 includes additional stages not shown in FIG. 2. For example, in some embodiments, and prior to any of the stages shown in FIG. 2, the dimension reduction unit 140 operates in conjunction with the classification unit 144 to generate outputs that facilitate “feature engineering,” e.g., by identifying which parameter values are most heavily relied upon by the classification model 132 when making inferences or predictions. For example, the dimension reduction unit 140 may apply a PCA technique to reduce 20 input parameters down to two dimensions, and also generate an indicator of how heavily the value of each of those 20 input parameters was relied upon (e.g., weighted) when the dimension reduction unit 140 calculates values for those two dimensions. Thereafter, training and execution of the classification model 132 may be based solely on the most important input parameters (e.g., the parameters that were shown to have the most predictive strength).

In some embodiments and/or scenarios, stages 204 through 220 all occur prior to the primary intended use of the equipment 102. If the equipment 102 is intended for use in the commercial manufacture of a biopharmaceutical drug product, for example, stages 204 through 220 may occur before the equipment 102 is used during the commercial manufacture process for that drug product. In this manner, the risk of unacceptable equipment performance occurring during production may be greatly reduced, thereby lowering the risk of costs and delays due to “down time,” and/or preventing quality issues. As another example, if the equipment 102 is intended for use in the product development stage, stages 204 through 220 may occur before the equipment 102 is used during that development process, potentially lowering costs and drug development times. In some embodiments, however, stages 210 through 220 (or just stages 210 through 216) also occur, or instead occur, during the primary use of the equipment 102 (e.g., during commercial manufacture or product development).

In some scenarios, new types of equipment deficiencies may be discovered during the process 200. For example, a recommended action output at stage 220 may fail to mitigate or prevent a particular equipment problem. In that case, subject matter experts may study the problem to identify a “fix.” Once the fix is identified, the problem can be manually re-created, to create additional training data in the historical database 150. The classification model 132 can then be modified and retrained, now with an additional classification corresponding to the newly identified problem. Moreover, the expert knowledge database 152 can be expanded to include the appropriate mitigating or preventative action(s) for that problem.

In some instances, it may be impractical to develop new training data on a scale that allows the classification model 132 to accurately identify certain equipment issues. In these cases, the classification model 132 may be supplemented with “hard coded” classifiers (e.g., fixed algorithms/rules to identify a particular type of equipment deficiency).

Performance of a system and process similar to the system 100 and process 200 was tested with about 20 different combinations of feature engineering techniques (e.g., PCA, PPCA, etc.) and classification models (e.g., SVM, decision tree, etc.), for the example case of a “steam-in-place” sterilization tank. The best performance for that particular use case was provided by using a PCA technique to reduce the n-dimensional data (for n features/inputs) to two dimensions, and an SVM classification model, which resulted in about 94% to 97% classification accuracy, depending on which data was randomly selected to serve as the testing and training datasets, and depending on the equipment under consideration. Overall accuracy for a SVM classification model with PCA, across different datasets and equipment, was about 95%. FIG. 4 depicts a plot 400 showing example classifications that were made by the SVM classification model. The x- and y-axes of the plot 400 represent values generated using a PCA technique (e.g., as may be generated by the dimension reduction unit 140). In the plot 400, the dashed lines represent decision boundaries dividing the three possible classifications of this example: good performance (classification 402); deficiency type A (classification 404); and deficiency type B (classification 406). Specifically, deficiency type A corresponds to an issue with oscillation of temperature readings during warm up, and deficiency type B corresponds to an issue with overshoot of temperature (i.e., the first two deficiencies reflected in Table 1 above).

Across different datasets and equipment, random forest classification with PCA also performed well, providing about 96% overall accuracy. However, SVM classification was more consistently accurate across all use cases examined. NBC classification, decision tree classification, and KNN classification (each with PCA) provided overall accuracy of about 89%, 89%, and 85%, respectively.

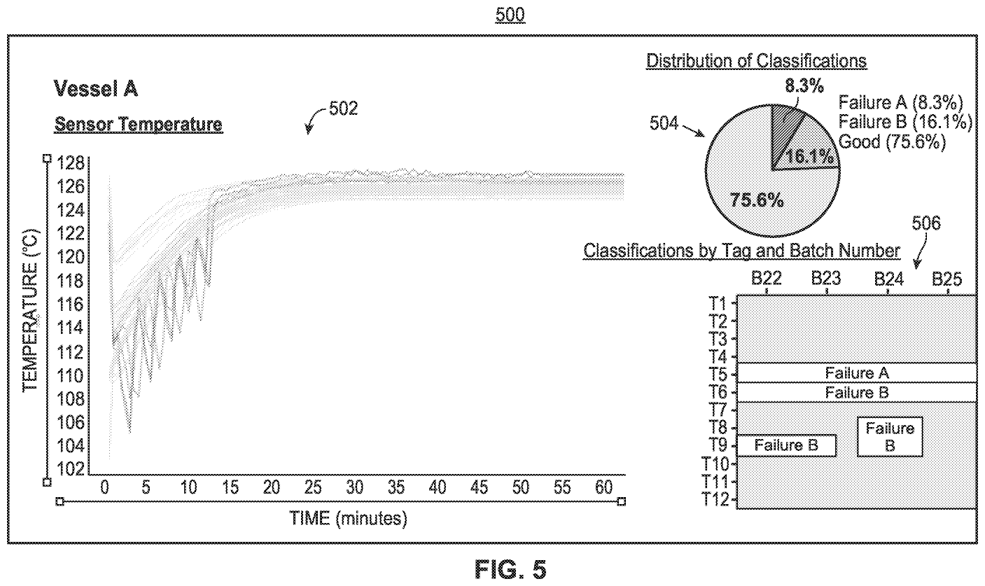

FIG. 5 depicts an example presentation 500 that may be generated and/or populated by the computing system 110 of FIG. 1. For example, the equipment analysis application 130 may generate and/or populate the presentation 500, for viewing on the display 124 and/or one or more other displays of one or more other devices (e.g., user mobile devices, etc.). Generally, the presentation 500 depicts information indicative of the classifications (by the classification model 132) for each of a number of runs, along with information (here, temperature readings) associated with those classifications.

As seen in FIG. 5, in this example, the presentation 500 includes a plot 502 that overlays a number of temperature traces. Each temperature trace may represent the temperature sensor data (e.g., generated by one of the sensor device(s) 104) that the classification model 132 analyzed/processed in order to output one classification (in this example, “Failure A,” “Failure B,” or “Good”). A pie chart 504 of the presentation 500 shows the number of each classification as a percentage of all classifications made by the classification model 132. A chart 506 of the presentation 500 shows results (i.e., particular failure types, if any) for a number of different batches and tags. Each batch (B22, B23, etc.) may refer to a different lot of materials (e.g., a particular lot of a drug product/substance being manufactured), and each tag (T1, T2, etc.) may refer to a different piece of equipment or a different equipment component (e.g., a particular temperature sensor). It is understood that, in other embodiments, the presentation 500 may include less, more, and/or different information than what is shown in FIG. 5, and/or may show information in a different format.

In some embodiments, the equipment analysis application 130 also (or instead) generates and/or populates other types of presentations. In some embodiments, for example, the equipment analysis application 130 generates or populates a text-based message or visualization for each run/classification (e.g., at stage 220 of FIG. 2), with the text-based message or visualization indicating the classification output by the classification model 132, as well as the recommended action or actions to which the classification was mapped. The equipment analysis application 130, or another application, may cause the text-based message or visualization to be presented to one or more users (e.g., via emails, SMS text messages, dedicated application screens/displays, etc.).

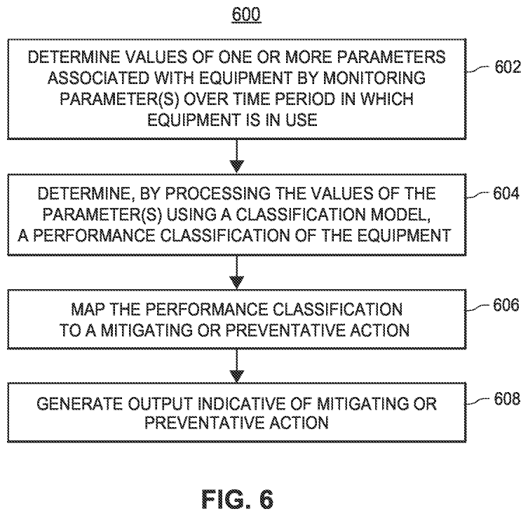

FIG. 6 is a flow diagram of an example method 600 for mitigating or preventing equipment performance deficiencies. The method 600 may be implemented by a computing system (e.g., computing device or devices), such as the computing system 110 of FIG. 1 (e.g., by the processing unit 120 executing instructions of the equipment analysis application 130), for example.

At block 602, values of one or more parameters associated with equipment (e.g., the equipment 102) are determined by monitoring the parameter(s) over a time period during which the equipment is in use (e.g., during a sterilization operation, or during a harvesting operation, etc., depending on the nature of the equipment). The parameter(s) may include temperature, pressure, pH level, humidity, or any other suitable type of physical characteristic associated with the equipment. Block 602 may include receiving the parameter values, directly or indirectly, from one or more sensor devices (e.g., the sensor device(s) 104) that generated the values. In other embodiments (e.g., if the method 600 is performed by the system 100 as a whole), block 602 may include the act of generating the values (e.g., by the sensor device(s) 104). The time period may be any suitable length of time (e.g., 10 minutes, six hours, one day, etc.), and within that time period the parameter values may correspond to measurements taken at any suitable frequency (e.g., once per second, once per minute, etc.) or frequencies (e.g., in some embodiments where multiple sensor devices are used).

At block 604, a performance classification of the equipment is determined by processing the values determined at block 602 using a classification model. The classification model (e.g., the classification model 132) may include an SVM model, a decision tree model, a deep neural network, a KNN model, an NBC model, an LSTM model, an HDBSCAN clustering model, or any other suitable type of model that can classify sets of input data as one of multiple available classifications. The classification model may be a single trained model, or may include multiple trained models.

At block 606, the performance classification is mapped to a mitigating or preventative action. Block 606 may include using the performance classification as a key to a database (e.g., expert knowledge database 152), for example. That is, block 606 may include determining which action corresponds to the performance classification in such a database. In some embodiments, the performance classification is also mapped to one or more additional mitigating or preventative actions, which may include actions that should be taken cumulatively (e.g., clean component A and inspect component B), and/or actions that should be considered as alternatives (e.g., clean component A or replace component A).

At block 608, an output indicative of the mitigating or preventative action is generated. In some embodiments, the output is also indicative of the performance classification that was mapped to the action (e.g., a code corresponding to the classification, and/or a text description of the classification). Moreover, in some embodiments, the output may include information indicative of classifications and/or corresponding actions for each of multiple time periods in which the equipment was used. The output may be a visual presentation (e.g., on the display 124), a portion of a visual presentation (e.g., specific fields or charts, etc.), or data used to generate or trigger any such presentation, for example. In some embodiments, block 608 includes generating data to populate a web-based report that can be accessed by multiple users via their web browsers.

In some embodiments, the method 600 also includes one or more additional blocks not shown in FIG. 6. For example, the method 600 may also include a block, prior to block 602, in which the classification model is trained using sets of historical values of the parameter(s), and respective labels for those sets (e.g., “Good” “Failure Type A,” etc.). The method 600 may also include blocks, after block 604 (and possibly also after blocks 606 and/or 608), in which a user-assigned label representing a manual classification for the parameter value(s) (e.g., “Good,” “Failure Type A,” etc.) is received (e.g., via the user input device 126 after a user entry), and the classification model is then further trained using the value(s) determined at block 602 and the user-assigned label.

Embodiments of the disclosure relate to a non-transitory computer-readable storage medium having computer code thereon for performing various computer-implemented operations. The term “computer-readable storage medium” is used herein to include any medium that is capable of storing or encoding a sequence of instructions or computer codes for performing the operations, methodologies, and techniques described herein. The media and computer code may be those specially designed and constructed for the purposes of the embodiments of the disclosure, or they may be of the kind well known and available to those having skill in the computer software arts. Examples of computer-readable storage media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as ASICs, programmable logic devices (“PLDs”), and ROM and RAM devices.

Examples of computer code include machine code, such as produced by a compiler, and files containing higher-level code that are executed by a computer using an interpreter or a compiler. For example, an embodiment of the disclosure may be implemented using Java, C++, or other object-oriented programming language and development tools. Additional examples of computer code include encrypted code and compressed code. Moreover, an embodiment of the disclosure may be downloaded as a computer program product, which may be transferred from a remote computer (e.g., a server computer) to a requesting computer (e.g., a client computer or a different server computer) via a transmission channel. Another embodiment of the disclosure may be implemented in hardwired circuitry in place of, or in combination with, machine-executable software instructions.

As used herein, the singular terms “a,” “an,” and “the” may include plural referents, unless the context clearly dictates otherwise.

As used herein, the terms “connect,” “connected,” and “connection” refer to (and connections depicted in the drawings represent) an operational coupling or linking. Connected components can be directly or indirectly coupled to one another, for example, through another set of components.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, two numerical values can be deemed to be “substantially” the same if a difference between the values is less than or equal to ±10% of an average of the values, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

While the present disclosure has been described and illustrated with reference to specific embodiments thereof, these descriptions and illustrations do not limit the present disclosure. It should be understood by those skilled in the art that various changes may be made and equivalents may be substituted without departing from the true spirit and scope of the present disclosure as defined by the appended claims. The illustrations may not be necessarily drawn to scale. There may be distinctions between the artistic renditions in the present disclosure and the actual apparatus due to manufacturing processes, tolerances and/or other reasons. There may be other embodiments of the present disclosure which are not specifically illustrated. The specification (other than the claims) and drawings are to be regarded as illustrative rather than restrictive. Modifications may be made to adapt a particular situation, material, composition of matter, technique, or process to the objective, spirit and scope of the present disclosure. All such modifications are intended to be within the scope of the claims appended hereto. While the techniques disclosed herein have been described with reference to particular operations performed in a particular order, it will be understood that these operations may be combined, sub-divided, or re-ordered to form an equivalent technique without departing from the teachings of the present disclosure. Accordingly, unless specifically indicated herein, the order and grouping of the operations are not limitations of the present disclosure.

1. A method of mitigating or preventing equipment performance deficiencies, the method comprising:
determining values of one or more parameters associated with equipment by monitoring the one or more parameters over a time period in which the equipment is in use;
determining, by a computing system processing the values of the one or more parameters using a classification model, a performance classification of the equipment;
mapping, by the computing system, the performance classification to a mitigating or preventative action; and
generating, by the computing system, an output indicative of the mitigating or preventative action.

2. The method of claim 1, wherein:
the classification model is configured to output, for a given set of parameter values, one of a plurality of available classifications, the plurality of available classifications including (i) a classification indicating that mitigating or preventative actions are not recommended, and (ii) one or more other classifications indicating that mitigating or preventative actions are recommended; and
determining the performance classification includes outputting, by the classification model, one of the one or more other classifications.

3. The method of claim 2, wherein the one or more other classifications include a plurality of classifications that each correspond to a different diagnosis or prediction associated with deficient performance of the equipment.

4. The method of claim 1, wherein the classification model includes (a) a support vector machine (SVM) model, (b) a decision tree model, or (c) a neural network.

5. (canceled)

6. (canceled)

7. The method of claim 1, wherein monitoring the one or more parameters includes receiving, by the computing system, sensor readings generated by one or more sensor devices.

8. The method of claim 7, wherein the equipment includes the one or more sensor devices.

9. The method of claim 7, wherein the one or more sensor devices include one or both of (i) one or more temperature sensors, and (ii) one or more pressure sensors.

10. The method of claim 7, wherein:
the sensor readings are generated by a plurality of sensor devices; and
determining the values of the one or more parameters includes generating the values by applying a dimension reduction technique to the sensor readings.

11. The method of claim 1, wherein mapping the performance classification to the mitigating or preventative action includes determining which action corresponds to the performance classification in a database containing known mitigating or preventative actions for known scenarios associated with the equipment.

12. The method of claim 1, wherein generating the output indicative of the mitigating or preventative action includes presenting the output to a user via a display.

13. The method of claim 1, further comprising, prior to determining the values of the one or more parameters associated with the equipment:
training the classification model using (i) a plurality of sets of historical values of the one or more parameters and (ii) a plurality of respective labels.

14. The method of claim 13, further comprising, after determining the performance classification of the equipment:
receiving, by the computing system, a user-assigned label representing a manual classification for the values of the one or more parameters; and
further training the classification model using (i) the values of the one or more parameters and (ii) the user-assigned label.

15. The method of claim 1, wherein:
the equipment includes a tank and one or more temperature sensors;
monitoring the one or more parameters includes receiving, by the computing system, sensor readings generated by the one or more temperature sensors;
the classification model is configured to output, for a given set of parameter values, one of a plurality of available classifications, the plurality of available classifications including (i) a classification indicating that mitigating or preventative actions are not recommended, and (ii) a plurality of other classifications that each correspond to a different diagnosis or prediction associated with deficient performance of the equipment;
the plurality of other classifications include one or more of (i) one or more classifications corresponding to temperature drop-out, (ii) one or more classifications corresponding to temperature oscillation, or (iii) one or more classifications corresponding to temperature overshoot; and
determining the performance classification includes the classification model outputting one of the plurality of other classifications.

16. A system for mitigating or preventing equipment performance deficiencies, the system comprising:
a computing system with one or more processors and one or more non-transitory, computer-readable media, the one or more non-transitory, computer-readable media storing instructions that, when executed by the one or more processors, cause the computing system to
determine values of one or more parameters associated with the equipment by monitoring the one or more parameters over a time period in which the equipment is in use,
determine, by processing the values of the one or more parameters using a classification model, a performance classification of the equipment,
map the performance classification to a mitigating or preventative action, and
generate an output indicative of the mitigating or preventative action.

17. The system of claim 16, wherein:
the classification model is configured to output, for a given set of parameter values, one of a plurality of available classifications, the plurality of available classifications including (i) a classification indicating that mitigating or preventative actions are not recommended, and (ii) one or more other classifications indicating that mitigating or preventative actions are recommended; and
determining the performance classification includes outputting, by the classification model, one of the one or more other classifications,
wherein the one or more other classifications optionally include a plurality of classifications that each correspond to a different diagnosis or prediction associated with deficient performance of the equipment.

18. (canceled)

19. The system of claim 16, wherein the classification model includes a support vector machine (SVM) model, a decision tree model, or a neural network.

20. The system of claim 16, wherein:
the equipment includes one or more sensor devices optionally including one or both of (i) one or more temperature sensors, and (ii) one or more pressure sensors; and
monitoring the one or more parameters includes receiving sensor readings generated by the one or more sensor devices.

21. (canceled)

22. The system of claim 20, wherein:
the one or more sensor devices include a plurality of sensor devices; and
determining the values of the one or more parameters includes generating the values by applying a dimension reduction technique to the sensor readings.

23. The system of claim 16, wherein mapping the performance classification to the mitigating or preventative action includes determining which action corresponds to the performance classification in a database containing known mitigating or preventative actions for known scenarios associated with the equipment.

24. The system of claim 16, further comprising:
a display,
wherein generating the output indicative of the mitigating or preventative action includes presenting the output to a user via the display.
